(19) United States
(12) Patent Application Publication
(10) Pub. No.: US 2008/0109515 A1
(43) Pub. Date: May 8, 2008

(54) SYSTEM AND METHOD FOR REGULATING A SHARED CONNECTION

(75) Inventors: Chandrasekaran Radhakrishnan, Waukesha, WI (US); Jay Khan, Piscataway, NJ (US)

Correspondence Address: PETER VOGEL;GE HEALTHCARE, 3000 N. GRANDVIEW BLVD., SN-477, WAUKESHA, WI, 53188, US

(73) Assignee: GENERAL ELECTRIC COMPANY, Schenectady, NY (US)

(21) Appl. No.: 11/557,519

(22) Filed: Nov. 8, 2006

(51) Int. Cl. G06F 15/16

(52) U.S. Cl. 709/204

(57) ABSTRACT

A system operable to regulate a shared connectivity with a client system having a client display is provided. The system includes a remote computer station in communication with a server connected in communication with the client system, and a graphic interface illustrated on the client display of the client system. The graphic interface allows a client single click control in initiating and interrupting shared connectivity of the client system with the remote computer station.

### BACKGROUND OF THE INVENTION

This invention generally relates to a web-based support system, and more specifically to a system and method for initiating connection of a remote computer station via the Internet to a client system.

Management and maintenance of computers, computer networks and other various network systems can be complex and costly in terms of labor and down time to service. Customers are driving demand for fast and reliable service at a low cost. Technology has been developed to allow remote connectivity of a support staff located at remote computer station or terminal so as to enhance service support of client systems.

Yet, there is a need for an enhanced remote support that is simpler for a client to initiate, and that provides enhanced illustration and control of shared connectivity status to the client.

### BRIEF DESCRIPTION OF THE INVENTION

The above-mentioned needs are addressed by the embodiments described herein in the following description.

In one embodiment, a system operable to regulate a shared connectivity with a client system having a client display is provided. The system includes a remote computer station in communication with a server connected in communication with the client system, and a graphic interface illustrated on the client display of the client system. The graphic interface allows a client single click control in initiating and interrupting shared connectivity of the client system with the remote computer station. In the exemplary system, selection of the first link causes communication of an identifier data and an initialization data to the server. An example of the initialization data includes an address of the client system and an address of the remote computer station to be granted access to share connectivity with one another. The first link includes a graphic virtual image of a selector button. The exemplary embodiment of the graphic interface also includes a status indicator configured to illustrate a real-time status of the shared connectivity of the remote computer terminal with the client system, a second link that when moved interrupts the shared connection of the remote computer terminal with the client system, an about link that when selected initiates the client system to illustrate a plurality of installation information data of the client system on the client display, and an identifier indicator illustrative of an identifier data of the client system. The system includes agent software stored at the client system, the agent software including a plurality of computer readable program instructions for illustrating the graphic interface on the display of the client system.

An embodiment of a method of regulating a shared connection of a remote computer terminal with a client system having a display is also provided. The method includes the acts of displaying a graphic interface on a display of the client system, the display including a graphic virtual image of a first link; detecting a selection of the first link indicative of a request for a shared connectivity with the remote computer station; generating a signal representative of the request for the shared connectivity; and initiating shared connectivity of the remote computer station with the client system in response to the signal representative of the approval.

An embodiment of an article of manufacture operable to enable shared connectivity of a remote computer station with a client system via a server is also provided. The article of manufacture includes a computer readable storage medium comprising a plurality of program instructions for execution by a processor in communication with a display. The plurality of program instructions include displaying a graphic interface on a display of the client system, detecting a selection of a first link on the graphic interface, initiating a shared connectivity of a remote computer station with the client system in response to detecting the selection, detecting a selection of a second link on the graphic interface; and interrupting the shared connectivity in response to detecting the selection of the second link.

Systems and methods of varying scope are described herein. In addition to the aspects and advantages described in this summary, further aspects and advantages will become apparent by reference to the drawings and with reference to the detailed description that follows.

### BRIEF DESCRIPTION OF THE DRAWINGS

FIG. 1 shows a schematic diagram of an embodiment of a system operable to enable shared connection of a customer computer terminal with a remote computer terminal.

FIG. 2 shows a schematic diagram of an embodiment of a graphic user interface illustrated at the customer computer terminal.

FIG. 3 shows a schematic block diagram of an embodiment of a method of regulating a shared connectivity of the remote computer station with the client system shown in FIG. 1.

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

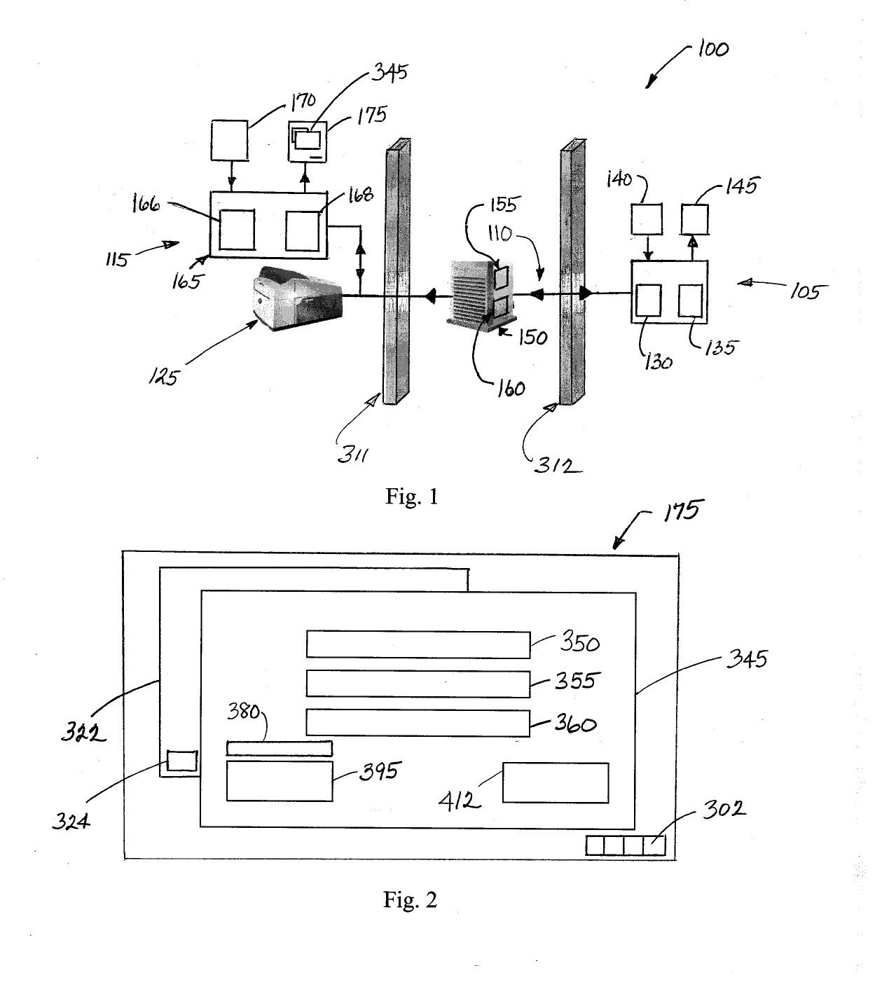

FIG. 1 illustrates an embodiment of a system 100 operable to provide shared connectivity of a remote computer station or terminal 105 via a network connection 110 (e.g., Internet, intranet, etc.) to a client system 115. A technical effect of the shared connectivity generally allows a support personnel at the remote computer station 105 readily simultaneous shared access with the client system 115 so as examine or service a client machine 125 under the control of a client at the client system 115.

The exemplary remote computer station or terminal 105 includes a computer having a processor 130 in communication with a memory 135, an input 140 and a display 145. The remote computer station 105 can include be a laptop or a desktop computer. An example of the input 140 is a keyboard in combination with a mouse device. Yet, the type of input 140 (e.g., touch-screen, etc.) can vary. An example of the display 145 includes a liquid crystal display (LCD) monitor, yet the type of display 145 (e.g., plasma monitor, cathode ray tube (CRT) monitor, LEDs, etc.) can vary. The number and type of inputs 140 and displays 145 can vary.

Still referring to FIG. 1, a server or gateway 150 is connected in communication between the remote computer station 105 and the client system 115. The server 150 generally includes at least one processors 155 operable in a conventional manner to manage traffic to or from the remote computer terminal. The server 150 is also generally operable to encrypt data exchanged between the remoter computer station 105 and the client system 115. The exemplary embodiment of the server 150 includes a memory 160 operable to store computer-readable program instructions for execution by the at least one processor 155. An example of the server 150 includes a Solaris Enterprise platform as manufactured by SUN® Microsystems, Inc. Yet, the type of server 150 can very.

In one embodiment of the server 150, the memory 160 stores an application suite for execution by the at least one processor 155. The application suite includes computer-readable program instructions to the at least one processor 155 so as to execute the shared connection and access to the client system 155 for remotely monitoring and managing operation of the machine 125, for remotely capturing and measuring machine 125 activity and performance, for remotely diagnosing and fixing faults, and for delivering software and upgrading of software to the machine 125 associated with the client system 115. An exemplary application suite is manufactured by QUESTRA®. Yet, the type of application suite can vary.

An embodiment of the client system 115 includes a client terminal 165 connected in communication to the client machine 125 to be serviced. The client terminal 165 can be integrated with the client machine 125, or interconnected via a network connection (e.g., Internet, intranet, etc.). Examples of the client terminal 165 can include a computer (e.g., a laptop or desktop), a personal data assistant (PDA), or other conventional interface in communication with the machine 125. The illustrated embodiment of the client terminal 165 includes a processor 166 in communication with a memory 168, an input 170 and a display 175. Examples of the input 170 include a keypad, keyboard, mouse device, touch-screen, etc. Examples of the display 175 include a liquid-crystal monitor, cathode ray tube monitor, plasma monitor, light emitting diodes (LEDs), etc. The exemplary client system 115 further includes a web browser operable in a conventional manner to view web pages received via the network connection 110 for illustration on the display 175.

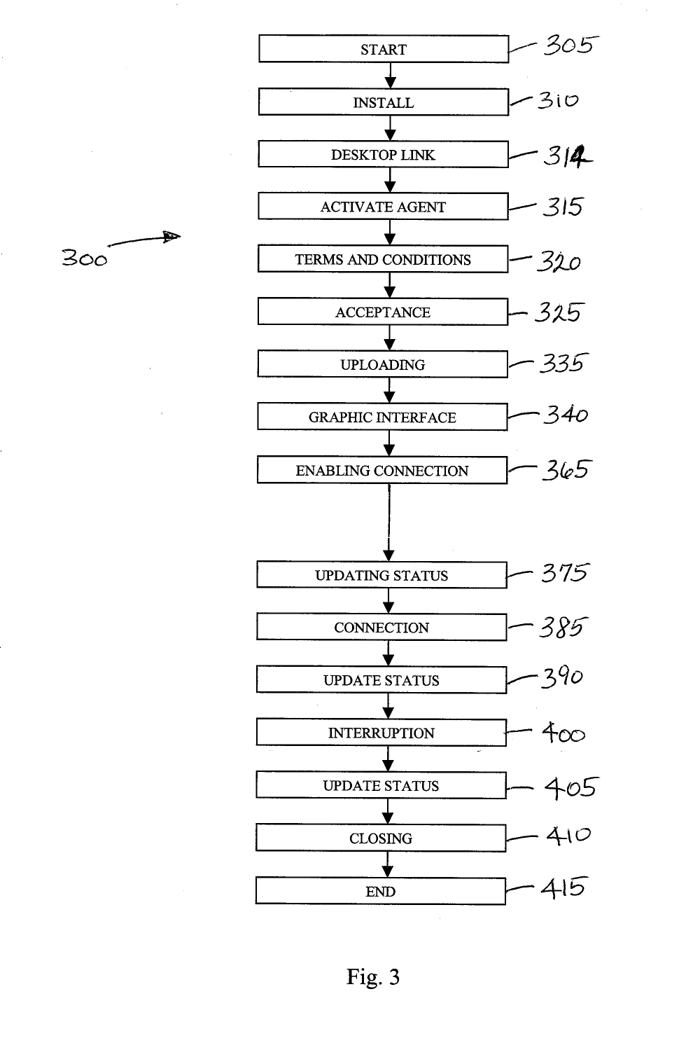

Having described the general construction of the system 100, remote computer station 105 and the client system 115, FIG. 3 illustrates an embodiment of a method 300 of operating the system 100 so as to selectively initiate a shared connection by the remote computer station 105 with the client system 115. It should be understood that the foregoing sequence of acts comprising the method 300 can vary, that the method 300 does not need to include each every act described herein, and the method 300 can include additional acts not described herein. One or more of the following acts comprising the method 300 can be represented as a series of modules of program instructions.

Assume the system 100 is installed such that the server 150 is connected in communication between the remote computer station 105 and the client system 115. Referring now to FIG. 2, an example of the installation includes providing a desktop link 302 for illustration on the display 175 of the client system 115 (See FIG. 1) for selection (e.g., clicking of mouse device) by the client to request shared connectivity by the remote computer station 105 (See FIG. 1). An example of the desktop link 302 is an icon or graphic virtual image operable to be clicked by a mouse device, pointer, keyboard, keypad, touchscreen, or other conventional selector device associated with a computer terminal.

Act 305 includes the start of the method 300. Act 310 installing an agent software comprising a series of modules of program instructions representative of one or more acts of the method 300 in the memory 168 for execution by the processor 166 of the client system 115. The agent software generally lies dormant until prompted to activate via a directive from the client. The act 310 further includes storing an identifier or serial number and internet or intranet address for the machine 125 to be serviced by the remote computer station 105, storing initialization data so as to allow access by ther server 150 and automatic passage through firewalls 311 and 312 between the client system 115 and the remote computer station 105, storing supplier and maintenance data for the machine 125 to be serviced, and other miscellaneous data as predetermined by support personnel at the remote computer station 105 so as to service the machine 125.

Act 314 includes detecting a request for a shared connection to the remote computer station 105. An example of the request includes receiving a signal in response to selection of the desktop link 302 illustrated on the display 175 of the client system 115. Act 314 further includes communicating a signal representative of the request for the shared connection to the client system 115. Act 315 includes activating the agent software stored in the memory 168 of the client system or in the memory 160 of the server 150. Act 320 includes communicating a terms and condition graphic interface 322 including an illustration of terms and conditions for the shared connection by support staff at the remote computer station to the client system. The terms and conditions graphic interface 322 also includes a terms link 324 that upon selection represents acceptance of the illustrated terms and conditions. Act 325 includes detecting acceptance of the terms and conditions for the shared connectivity. An example of act 325 includes receiving a signal generated in response to a selection of the terms link 324.

Act 335 includes automatically uploading identifier data (e.g., serial number of machine) and initialization data (e.g., web address, machine manufacturer or supplier, etc.) to allow remote shared access or connection to service the machine 125. The identifier data and initialization data can be entered and stored at the client system 115 or server 150. Thus, the client does not need to search and manually enter identifiers, addresses, etc. necessary to allow shared connectivity so as to allow servicing of the machine 125 from the remote computer station 105. Act 335 can also include uploading installation data or other applicable information to service the machine 125, to order replacement parts, supplier information, or to verify if under warranty.

Act 340 includes communicating a connectivity graphic interface 345 for illustration on the display 175 of the client system 115. An example of the connectivity graphic interface 345 includes a web-based, graphic image of a tile created using programming tool such as VCC++ and compatible with a MICROSOFT WINDOWS® operating system. Yet, other types of programming tools (e.g., Visual Basic) and operating systems can be employed with the connectivity graphic interface 345. An embodiment of act 340 also includes illustrating an identity indicator 350 on the graphic interface 340. The identity indicator 350 is generally operable to show identifier data (e.g., serial number) of the machine 125 to be serviced by support staff via the shared connectivity of the remote computer station 105 with the client system 115. Act 340 also includes illustrating a virtual graphic image of a first link 355 and a second link 360 on the graphic interface 345 to control the shared connectivity with the remote computer station 115. An example of the first and second links 355 and 360 includes virtual graphic images of buttons operable to pressed or selected with a mouse, pressing the enter key on the keyboard, or via a touch-screen. The type of graphic virtual images employed for the links 355 and 360 can vary. The first link 355 can be labeled ENABLE, and the second link 360 can be labeled DISABLE or INTERRUPT.

Act 365 includes enabling the shared connection with the remote computer station 105. An embodiment of act 365 includes detecting a press or selection of the first link 355 and communicating a signal to the server 150 indicative of a request or poll for the shared connectivity that allows access by the remote computer station 105 to the machine 125 of the client system 115. Act 365 also includes communicating the identifier data and initialization data to the server 150 so as to enable access from the remote computer station 105. The identifier data and initialization data include the address of the client system 115 and the remote computer station 105 to share connectivity one another via the server 150, as well as other miscellaneous information to allow the remote computer station 105 access via the server 150 and passage through security firewalls 311 and 312 between the client system 115 and the remote computer station 105. The act 365 may further include encrypting the identifier data and initialization data at the server 150 before communicating to the remote computer station 105.

Act 375 includes updating a status indicator 380 shown on the graphic interface 345. The status indicator 380 is generally operable to illustrate a real-time status of the shared connection of the remote computer station 105 with the client system 115. During communicating the identification data and initialization data to the remote computer station 105, the status indicator 380 can be configured to illustrate CONNECTION IN PROGRESS on the graphic interface 345 on the display 175 for viewing by the client.

Act 385 includes logging in from the remote computer station 105 into the server 150 and establishing the shared connectivity with the machine 125 of the client system 115 to be serviced. Act 390 includes updating the status indicator 380 to indicate SUCCESSFUL CONNECTION. Once shared connectivity is established with the client system 115, personnel at the remote computer station 105 can service the machine 125, add or modify software to the client system 115, etc. as desired by the client.

The graphic interface 345 further includes a third link 395, similar to the first and second links 350 and 355 described above. The third link 395 is represented by a graphic virtual image of a button labeled ABOUT. When selected, the third link 395 initiates illustration of a plurality of machine maintenance or machine installation data on the client display 175.

A technical effect of the links 355 and 360 of the graphic interface 345 is to enable the client to be in control so as to start and stop the shared connectivity with the remote computer station 105 at any time. Act 400 includes interrupting the shared connectivity with the remoter computer station 105. An embodiment of the act 400 includes detecting a request for the interruption from interruption via a signal in response to selection of the second link 355 on the graphic interface 345, and generating a signal to the server 150 that causes interruption of the shared connectivity with the remote computer station 105. The second link 360 on the graphic interface 345 allows the client to interrupt the shared connection with one click of a mouse device or similar device at the graphic interface 345 on the display 175 at any desired time.

Although the first and second links 355 and 360 are illustrated as independent buttons, it should be understood that the first and second links 355 and 360 can be combined as a single button, where pressing the button a first time initiates signal to the server 150 so as to cause the shared connectivity of the client system 115 from the remote support station 105, and pressing the same button a second time initiates communication of the signal to the server 150 so as to interrupt the shared connectivity of the client system 115 with the remote support station 105.

Act 405 includes updating the status indicator 380 on the graphic interface 345 so as to illustrate interruption of the shared connection for viewing on the display 175 on the client system 115. Act 410 includes detecting a selection of a fourth link 412 illustrated on the graphic interface 345 so as to close illustration of the graphic interface 345 on the display 175 of the client system 115 and deactivate the agent software. Act 415 is the end of the method 300.

Although the graphic interfaces 322 and 345 are shown as tiles on a MICROSOFT WINDOWS® based operating system, other types of graphic interfaces can be employed for other types of operating systems (e.g., LINUX® operating system, etc.) and is not limiting on the invention. Also, it should be understood that an embodiment of an article of manufacture including any type of conventional computer-readable medium (e.g., disk, hard-drive of a computer, etc.) comprising a plurality of program instructions that include the acts 314, 315, 320, 325, 335, 340, 365, 370, 375, 385, 390, 400, 405 and 410 is contemplated by the subject matter described herein.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system operable to regulate a shared connectivity with a client system having a client display, comprising:
a remote computer station in communication with a server connected in communication with the client system; and
a graphic interface illustrated on the client display of the client system, the graphic interface including a first link that when selected allows the remote computer station access through the server and shared connectivity with the client system.

2. The system of claim 1, wherein selection of the first link causes communication of an identifier data and an initialization data to the server, the initialization data including an address of the client system and an address of the remote computer station to be granted access to share connectivity with one another.

3. The system of claim 1, wherein the first link includes a graphic virtual image of a selector button.

4. The system of claim 1, wherein the graphic interface includes a status indicator configured to illustrate a real-time status of the shared connectivity of the remote computer terminal with the client system.

5. The system of claim 1, wherein the graphic interface further includes an about link that when selected initiates the client system to illustrate a plurality of installation information data of the client system on the client display.

6. The system of claim 1, wherein the graphic interface includes a second link that when moved interrupts the shared connection of the remote computer terminal with the client system.

7. The system of claim 1, wherein the graphic interface includes an identifier indicator illustrative of an identifier data of the client system.

8. The system of claim 1, wherein the graphical interface regulates activation of an agent software so as to enable the shared connection.

10. A method of regulating a shared connection of a remote computer terminal with a client system having a display, the method comprising the acts of:
displaying a graphic interface on a display of the client system, the display including a graphic virtual image of a first link;
detecting a selection of the first link indicative of a request for a shared connectivity with the remote computer station;
generating a signal representative of the request for the shared connectivity; and
initiating shared connectivity of the remote computer station with the client system in response to the signal representative of the approval.

11. The method of claim 10, wherein the act of detecting the selection of the first link causes communication of an identifier data and an initialization data to a server connected in communication between the client system and the remote computer station, the initialization data including an address of the client system and an address of the remote computer station to be granted access to share connectivity with one another.

12. The method of claim 10, wherein the act of detecting a selection of the desktop link prompts activating an agent software stored at the client system, the agent software including a plurality of computer readable program instructions for illustrating the graphic interface on the display of the client system.

13. The method of claim 10, wherein the act of displaying the graphic user interface includes displaying a second link that when selected causes interruption of the shared connectivity with the remote computer station.

14. The method of claim 10, wherein the act of displaying the graphic interface includes displaying a third link that when selected closes the graphic interface illustrated on the display of the client system.

15. The method of claim 10, wherein the act of displaying the graphic interface includes displaying a connectivity status indicator indicative of a current status of the shared connectivity with the remote computer station.

16. The method of claim 15, wherein the method further comprises the act of updating the status indicator on the graphic interface in response to successful shared connectivity of the remote computer station with the client system.

16. The method of claim 14, wherein the method further comprises the act of updating the status indicator on the graphic interface in response to interrupting the shared connectivity with the remote computer station.

17. An article of manufacture operable to enable shared connectivity of a remote computer station with a client system via a server, the article of manufacture including a computer readable storage medium comprising a plurality of program instructions for execution by a processor in communication with a display, the plurality of program instructions comprising:
displaying a graphic interface on a display of the client system;
detecting a selection of a first link on the graphic interface;
initiating a shared connectivity of a remote computer station with the client system in response to detecting the selection;
detecting a selection of a second link on the graphic interface; and
interrupting the shared connectivity in response to detecting the selection of the second link.

18. The article of manufacture as recited in claim 17, the program instructions further comprising:
displaying a status indicator on the graphic interface, the status indicator illustrative of a status of the shared connection of the remote computer station with the client system.

19. The article of manufacture as recited in claim 17, wherein the act of initiating the shared connectivity includes communicating an identifier data and an initialization data to the server connected in communication between the client system and the remote computer station, the initialization data including an address of the client system and an address of the remote computer station to be granted access to share connectivity with one another.

20. The article of manufacture as recited in claim 17, wherein the act of displaying the graphic interface includes displaying a third link that when selected closes the graphic interface.
